(19) United States
(12) Patent Application Publication
(10) Pub. No.: US 2007/0115366 A1
(43) Pub. Date: May 24, 2007

(54) Moving image generating apparatus, moving image generating method and program therefore

(75) Inventor: Hisayoshi Tsubaki, Saitama (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD.

(21) Appl. No.: 11/529,536

(22) Filed: Sep. 29, 2006

(30) Foreign Application Priority Data
Nov. 18, 2005 (JP) JP2005-334373

(51) Int. Cl. H04N 5/225

(52) U.S. Cl. 348/220.1

(57) ABSTRACT

A moving image generating apparatus is provided, that efficiently generates a moving image representing transition of still images. The moving image generating apparatus that generates a moving image in which a plurality of still images are transferred includes: a transition data acquiring section that acquires transition data indicating how are the plurality of still images transferred in the moving image; and a moving image generating section that generates a plurality of moving image components compressed into each partial region from the plurality of still images based on the transition data acquired by the transition data acquiring section and that generates a compressed moving image including the plurality of generated moving image components. The moving image generating section generates a plurality of moving image components from the plurality of still images by defining a partial region included in the moving image component as the minimum unit of transition of still images in the moving image and generates a compressed moving image including the plurality of generated moving image components. The moving image generating section generates the plurality of continuous moving image components in which the transition region is transferred by the width for an integer number of partial regions in the moving image.

### CROSS REFERENCE TO RELATED APPLICATION

The present application relates to and claims priority from Japanese Patent Application No. JP 2005-334373 filed in Japan on Nov. 18, 2005, the contents of which are incorporated herein by reference for all purpose.

### BACKGROUND

1. Field of the invention

The present invention relates to a moving image generating apparatus, a moving image generating method and a program therefore. Particularly, the present invention relates to a moving image generating apparatus and a moving image generating method for generating a moving image from a still image, and a program for the moving image generating apparatus.

2. Related art

Generally, a system has been known, which generates moving data from plural pieces of still data provided from a customer and records the same. In the system, difference data indicative of transition of still images is added to still image data, so that moving data in which the still images are transferred is generated as disclosed in, for example, Japanese Patent Application Publication No. 2003-259303. The technology causes users to easily view photographic images by home moving image reproducing apparatus such as a DVD player and a computer terminal such as a PC.

However, any specific technology has not been disclosed in the above-described related art which efficiently generates a moving image indicative of transition of images. For example, any specific technology for efficiently generating moving data indicative of the transition of still images such as movement, enlargement, reduction, rotation and change of color tone of an object on the still image, fade-in and fade-out of the still image and a mosaic display for the still image.

### SUMMARY

Thus, an advantage of some aspects of the present invention to provide a moving image generating apparatus, a moving image generating method and a program therefore which are capable of solving the problem accompanying the conventional art. The above and other advantages can be achieved by combining the features recited in independent claims. Then, dependent claims define further effective specific example of the present invention.

In order to solve the above described problems, a first aspect of the present invention provides a moving image generating apparatus for generating a moving image in which a plurality of still images are transferred. The moving image generating apparatus includes: a transition data acquiring section for acquiring transition data indicating how are the plurality of still images are transferred in the moving image; and a moving image generating section for generating a plurality of moving image components compressed into each partial region from the plurality of still images and for generating a compressed moving image including the plurality of generated moving image components. The moving image generating section generates a plurality of moving image components from the plurality of still images by defining a partial region included in a moving image component as the minimum unit of transition of still images in the moving image and generates a compressed moving image including the plurality of generated moving image components.

The transition data acquiring section may acquire transition data indicating how does at least a part of transition region of the still images transfer in the moving image. The moving age gene-rig section may generate a plurality of moving image components in which the transition region is transferred by an width for an integral number of partial regions among continuous moving image components included in the moving image.

The moving image generating section may include a transition data converting section for converting the transition data indicative of transition of the transition region acquired by the transition data acquiring section to transition data indicative of transition by an-width for an integral number of partial regions and a moving image component generating section for generating a plurality of moving image components based on the transition data converted by the transition data converting section.

The transition data converting section may convert the transition data acquired by the transition data acquiring section to transition data of which transition path is more approximate to that of the transition data acquired by the transition data among the transition data indicative of transition by an width for an integral number of partial regions.

The moving image generating section may include a motion vector calculating section for calculating a motion vector in a transition region indicative of the difference between a position of the transition region in one moving image component and a position of the transition region in the other moving image component, and a moving image component generating section for generating an image content in the partial region included in the transition region among the plurality of moving image components in which the transition region is transferred by an width for an integral number of partial regions by representing the image contents is the same as the transfer region in the other moving image component based on the motion vector calculated by the motion vector calculating section.

The transition data acquiring section may acquire transition data indicating how does at least a part of change region in the still images change in the moving image. The moving image generating section may generate a plurality of moving image components in which the change region is changes every an integral number of the partial regions.

The moving image generating section may include a transition data converting section for converting the transition data acquired by the transition data acquiring section, which indicates the change of the change region to transition data indicative of the change for each of the integral number of partial regions, and a moving image component generating section for generating a plurality of moving image components based on the transition data converted by the transition data converting section.

The moving image generating section may include an identical partial region specifying section for specifying whether there is the partial region having the image content the same as each partial region other than the partial region which is transferring included in one moving image component in the other moving image components based on the transition data acquired by the transition data acquiring section, and a motion vector calculating section for calculating a motion vector indicative of the difference between a partial region specified by the identical partial region specifying section that there is the partial region having the same image content and a partial region included in the other moving image component having the image content the same as that of the former partial region. The moving image generating section may generate a moving image component including the moving vector calculated by the moving vector calculating section.

The moving image generating section may generate a plurality of moving image components compressed into each of the macroblocks from a plurality of still images by defining a macroblock included in a moving image component as the minimum unit of transition of still images in the moving image based on the transition data acquired by the transition data acquiring section and generate a compressed moving image including the plurality of generated moving image components, which is encoded by MPEG.

The image generating section includes: an I picture generating section for generating an I picture being a moving image component from at least one of still images based on the transition data acquired by the transition data acquiring section; a P picture generating section for generating a P picture being a moving image component based on the transition data acquired by the transition data acquiring section and the I picture generated by the I picture generating section; an identical partial region specifying section for specifying whether there is the partial region having the image content the same as that of each of the macroblocks other than the macroblock included in one P picture, which is transferring in the I picture generated by the I picture generating section or the p picture generated by the P picture generating section, which is reproduced at a timing before the P picture is reproduced based on the transition data generated by the transition data generating section; and a motion vector calculating section for calculating a motion vector indicative of the difference between a position of the macroblock specified by the identical partial region specifying section that there is the partial region having the same image content and a position of the partial region included in the I picture generated by the I picture generating section or the P picture generated by the P picture generating section of which image content is the same as that of the specified macroblock The P picture generating section may generate a P picture including the motion vector calculated by the motion vector calculating section, which represents the macroblock specified by the identical partial region specifying section that there is the partial region having the image content the same as that of the I picture or the P picture reproduced at the previous timing.

The moving image generating section may further include a B picture generating section for generating a B picture being a moving image component based on the transition data acquired by the transition data acquiring section, the I picture generated by the I picture generating section and the P picture generated by the P picture generating section. The identical partial region specifying section may specify whether there is the partial region having the image content the same as that of each of the macroblocks other than the macro blocks included in one B picture, which is transferring in the I picture generated by the I picture generating section or the P picture generated by the P picture generating section, which is reproduced at a timing before or after the toning at which the one B picture is reproduced. The motion vector calculating section calculates a motion vector indicative of the difference between the position of the macroblock specified by the identical partial region specifying section that there is the partial region having the same image content and the position of the partial region included in the I picture generated by the I picture generating section or the P picture generated by the P picture generating section which has the image content the same as that of the specified macroblock. The B picture generating section may generate a B picture including the motion vector calculated by the motion vector calculating section, which represents the macroblock specified by the identical partial region specifying section that there is the partial region having the image content same as that of the I picture or the P picture reproduced at a timing before or after the B picture is generated.

A second aspect of the present invention provides a moving image generating method for generating a moving image in which a plurality of still images are transferred. The moving image generating method includes the steps of: acquiring transition data indicating how are the plurality of images transferred in the moving image; and generating a plurality of moving image components compressed into each partial region from the plurality of sill images based on the transition data acquired in the transition data acquiring step and generating a compressed moving image including the plurality of generated moving image components. The moving image generating step includes generating the plurality of moving image components from the plurality of still images by defining a macroblock included in a moving image component as the minimum unit of transition of still images in the moving image and generating the compressed moving image including the plurality of generated moving image components.

The third aspect of the present invention provides a program for the moving image generating apparatus for generating a moving image in which a plurality of still images are transferred. The program causes the moving image generating apparatus to function as: a transition data acquiring section for acquiring transition data indicating how are the plurality of still images are transferred in the moving image; and a moving image generating section for generating a plurality of moving image components compressed into each partial region from the plurality of still images and for generating a compressed moving image including the plurality of generated moving image components. The program causes the moving image generating section to generate a plurality of moving image components from the plurality of still images by defining a partial region included in a moving image component as the minimum unit of transition of still images in the moving image and generate a compressed moving image including the plurality of generated moving image components.

Here, all necessary features of the present invention are not listed in the summary of the invention. The sub-combinations of the features may become the invention.

According to the present invention, a moving image generating apparatus for efficiently generating a moving image which represents transition of still images can be provided.

### BRIEF DESCRIPTION OF THE DRAWINGS

FIG. 1 shows an example of environment for the usage of a moving image generating apparatus 100;

FIG. 2 shows an example of block configuration of the moving image generating apparatus 100;

FIG. 3 shows an example of converting transition data;

FIG. 4 shows another example of moving data generated by a moving image generating section 214;

FIG. 5 shows an example of generating a moving image in which an object is transferred by a transition width smaller than the width of a macroblock; and

FIG. 6 shows an example of hardware configuration of the moving image generating section 100.

### DESCRIPTION OF EXEMPLARY EMBODIMENTS

Hereinafter, the present invention will now be described through preferred embodiments. The embodiments do not limit the invention according to claims and all combinations of the features described in the embodiments are not necessarily essential to means for solving the problems of the invention.

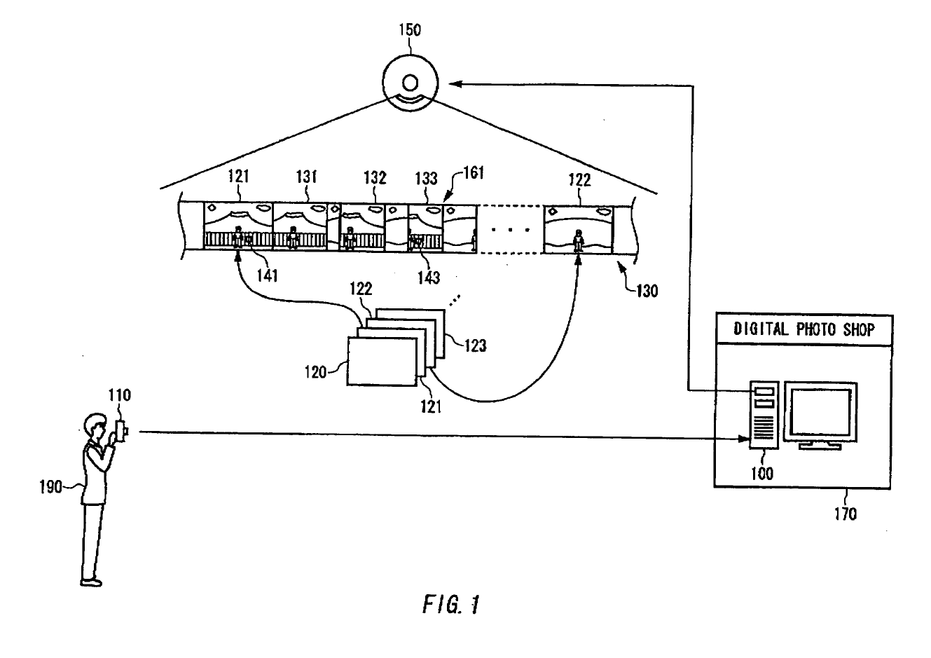

FIG. 1 shows an example of environment for the usage of a moving image generating apparatus 100 according to an embodiment. The moving image generating apparatus 100 receives still images 120, 121, 122, 123 . . . which are captured using an image capturing device 110 by a user 190 and generates a moving data 130 encoded by MPEG such as a slide show. At this time, the moving image generating section 100 processes the still images according to transition data in which transition of the still images such as motion of the still image are defined to generate a plurality of pictures encoded by MPEG, which is one fame image to be reproduced between the still images. In an example of FIG. 1, the moving image generating section 100 generates an moving image in which the still image 121 is firstly presented and the still image 122 is gradually presented from one end of the still image 121. In this case, the moving image generating apparatus 100 generates I pictures from each of the still image 121 and the still image 122, respectively.

The moving image generating apparatus 100 acquires transition data which defines a transition speed of a border line 161 between the still image 121 and the still image 122 in order to generate the moving image data 130 in which the still image 121 is transferred to the still image 122. Then, the moving image generating apparatus 100 calculates the position of the border line 161 in each of pictures 131, 132, 133 . . . from the acquired transition data and adjusts the calculated position of the border line 161 so as to locate the border line 161 on the border line of macroblocks. Thus, the moving image generating apparatus 100 adjusts the position of the border line 161 to the border line of the macroblockes to identify the image content of each of the macroblocks included in the right region or the left region bounded by the border line 161 with any macroblock included in the still image 121 or the still image 122. For example, the macroblock in a partial region 143 of the moving image component 133 of which image content is the same as that of the macroblock in the partial region 141 of the still image 121.

Then, the moving image generating apparatus 100 represents the image content of the macro block in the region 143 by a motion vector to the macroblock in the region 141. In the example of FIG. 1, the moving vector obtained by transferring the still image 121 is a moving vector in the moving image generating apparatus 100. Here, the moving image generating apparatus 100 generates the pictures 131, 132, 133 . . . which are reproduced between an interval of I pictures as P pictures or B pictures. Additionally, the moving image generating apparatus 100 may generate all of the pictures 131, 132, 133 . . . as P pictures or B pictures, or any one of the pictures 131, 132, 133 . . . as P pictures or B pictures.

As described above, the moving image generating apparatus 100 can represent by the motion vector the image contents of all of the macroblocks for pictures reproduced between an interval of continuous I pictures, so that the amount of moving image data can be significantly reduced. Additionally, the moving image generating apparatus 100 can directly calculate the motion vector from transition data without complicated processing such as calculating the motion vector by block matching after generating all pixel data for each of the frame images in the moving image. Therefore, the image data encoded by MPEG can be generated at a high speed.

Here, the moving image generating apparatus 100 may acquire an instruction from the designer who creates the moving image and the user 190 as transition data. Also the moving image generating apparatus 100 may acquire template data for generating a moving image which indicates effect on still images such as the movement of an object as the transition data The moving image generating apparatus 100 may provide the generated moving image by recording the same on a photorecording medium such as a DVD 150, and also may provide the generated moving image to the user 190 through a communication line such as Internet. Additionally, the moving image generating apparatus 100 may receive still images from the image capturing device 110 through a communication line such as Internet, and also may receive the still images recorded on a recording medium such as a semiconductor memory by the image capturing device 10. Here, a moving image generated by the moving image generating apparatus 100 may be a captured image and, other than the captured image, image data generated by using such as an image processing software. The moving image generating apparatus 100 may be a terminal for generating a moving image, which is provided on a digital photo shop 170, and also may be a terminal such as a personal computer provided on a user's house.

As described above, the moving image generating apparatus 100 according to the present embodiment can represent the macroblock for each of the pictures reproduced between an interval of the I pictures by the motion vector. Therefore, the moving image generating apparatus 100 can generate a moving image more speedily hand the case that firstly pixel data for each frame included in the moving image is generated and then the moving image is encoded by MPEG.

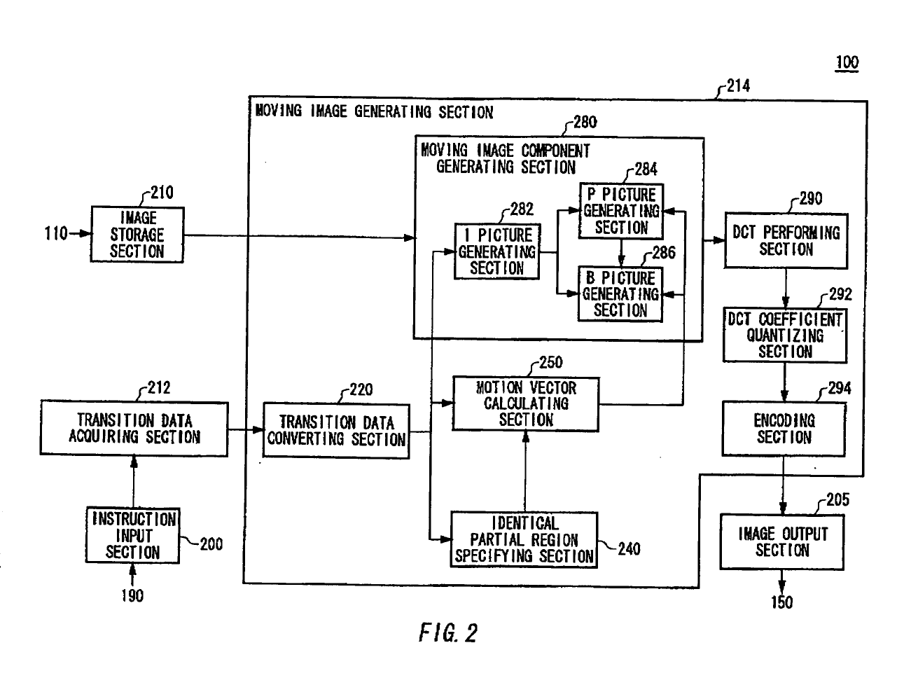

FIG. 2 shows an embodiment of block configuration of the moving image generating apparatus 100. The moving image generating apparatus 100 includes an instruction input section 200, an image output section 205, an image storage section 210, a transition data acquiring section 212 and a moving image generating apparatus 214. The moving image generating section 214 includes a transition data converting section 220, an identical partial region specifying section 240, a motion vector calculating section 250, a moving image component generating section 280, a DCT performing section 290, a DCT coefficient quantizing section 292 and an encoding section 294. The moving image component generating section 280 includes an I picture generating section 282, a P picture generating section 284 and a B picture generating section 286.

The image storage section 210 stores a plurality of still images. Transition data acquiring section 212 acquires transition data indicating how are the plurality of still images transferred in the moving image. Specifically, the transition data acquiring section 212 acquires an instruction inputted to the instruction input section 200 by the user 190, which instructs how are the still images transferred. Then, the moving image generating section 214 generates a plurality of moving image components compressed into each partial region from the plurality of still images based on the transition data acquired by the transition data acquiring section 212 and generates a compressed moving image including the plurality of generated moving image components. Here, the partial regions may be macroblocks for encoding by MPEG.

Specifically, the transition data acquiring section 212 acquires transition data indicating how are at least a part of transition region of the still images transferred in the moving image. Then, the transition data converting section 220 converts the transition data acquired by the transition data acquiring section 212, which indicates that the transition region has been transferred to transition data indicative of transition by an width for an integer number of partial regions. Then, the moving image component generating section 280 generates a plurality of moving image components based on the transition data converted by the transition data converting section 220.

Thus, the moving image generating section 214 generates a plurality of moving image components of which transition region is transferred by a width for an integral number of partial regions in the continuous moving image components included in the moving image. Accordingly, generating a moving image encoded by MPEG, the moving image generating apparatus 100 can transfer the transition region having a plurality of macroblocks by the width of a macroblock in each picture to match the macroblocks for each picture with the transition region. Therefore, the moving image generating apparatus 100 can represent the image content of the macroblocks for each picture by the motion vector indicative of the movement of the transition region by a macroblock and difference image data “0”.

Here, the transition data converting section 220 may convert the transition data acquired by the transition data acquiring section 212 to transition data of which transition path is more approximate to that of the transition data acquired by the transition data acquiring section 212 among the transition data indicative of the transition by the width for an integer number of partial regions. For example, the transition data converting section 220 calculates the position of the borderline of the transition region for each picture from the transition data in which a transition speed of the transition region is defined and converts the same to transition data in which the calculated border line of transition region is corresponded to the border line of the adjacent macroblock. The macroblocks included in the transition region are represented by the motion vectors, so that moving image components can be efficiently generated. Additionally, the moving image generating section 100 can approximate the transition of the transition region over the moving image components to the transition instructed by the user 190, so that the user 190 can view the moving image without feeling uncomfortable.

The motion vector calculating section 250 calculate the motion vector of the transition region indicative of the difference between the position of the transition region in one moving image component and the position of the transition region in the other moving image component based on the transition data acquired by the transition data acquiring section 212, which indicates that the transition region has been transferred. Then, the moving image component generating section 280 generates the image content of the partial region included in the transition region in the plurality of moving image components in which the transition region is transferred by the width for an integer number of partial regions by representing that the image content of the partial region included in the transition region in the plurality of moving image components is the same as the transition region in the other moving image components by the motion vector calculated by the motion vector calculating section 250.

The transition data acquiring section 212 may acquire transition data indicating how are at least a part of change regions of the still images changed in the moving image. At this time, the transition data convert section 220 converts the transition data acquired by the transition data acquiring section 212, which indicates the change of the change region to transition data indicative of the change for each of the integer number of partial regions. Then, the moving image component generating section 280 generates a plurality of moving image components based on the transition data converted by the transition data converting section 220. Thus, the moving image generating section 214 generates the plurality of moving image components in which the change region is changed for each of the integer number of partial regions.

In this case, the identical partial region specifying section 240 specifies whether there is any partial region having the image content the same as that of each partial region other than the partial region included in one moving image component, which is transferring in the other moving image components based on the transition data acquired by the Position data acquiring section 212. Then, the moving vector calculating section 250 calculates a moving vector indicative of the difference between the position of the partial region specified by the identical partial region specifying section 240 that there is the partial region having the same image content therein and the position of the partial region included in the other moving image component, of which image content is the same as the former partial region. Then, the moving image generating section 214 generates a moving image component including the motion vector calculated by the motion vector calculating section 250.

Here, generating a moving image encoded by MPEG, the moving image generating section 214 may generate a plurality of moving image components compressed into each macroblock from a plurality of still images by defining a macroblock included in a moving image component as the minimum unit of transition of still images in the moving image based on the transition data acquired by the transition data acquiring section 212, and generate a compressed moving image encoded by MPEG, which includes the plurality of generated moving image components. In this case, the I picture generating section 282 generates an I picture being a moving image component from at least a still image based on the transition data acquired by the transition data acquiring section 212. The P picture generating section 284 generates a P picture being a moving image component based on the transition data acquired by the transition data acquiring section 212 and the I picture generated by the I picture generating section 282.

The identical partial region specifying section 240 specifies whether there is any partial region having the image content the same as that of each macroblock other than the macroblock included in one P picture, which is transferring in the I picture generated by the I picture generating section 282 or the P picture generated by the P picture generating section which is generated at a timing before the P picture is reproduced. Then, the motion vector calculating section 250 calculates a motion vector indicative of the difference between the position of the macroblock specified by the identical partial region specifying section 240 that there is the partial region having the same image content therein and the position of the partial region included in the I picture generated by the I picture generating section 282 or the P picture generated by the P picture generating section 284, of which image content is the same as that of the specified macroblock. Then, the P picture generating section 284 generates a P picture including the motion vector calculated by the motion vector calculating section 250, which represents the macroblock specified by the identical partial region specifying section 240 that there is the partial region having the image content the same as that of the I picture or the P picture reproduced at the previous timing. Therefore, the motion vector of the macroblock can be directly calculated from the transition data, so that the moving image generating apparatus 100 can efficiently generate a moving image encoded by MPEG.

Now, it will be described about the operation of the moving image generating apparatus 100 to generate a B picture for encoding by MPEG. Here, the B picture generating section 286 generates a B picture being a moving image component based on the transition data acquired by the transition data acquiring section 212, the I picture generated by the I picture generating section 282 and the P picture generated by the P picture generating section 284. Specifically, the identical partial region specifying section 240 specifies whether there is any partial region having the image content the same as that of each macroblock other than the macroblock included in one B picture, which is transferring in the I picture generated by the I picture generating section 282 or the P picture generated by the P picture generating section 284, which is reproduced at a timing before or after the one B picture is reproduced based on the transition data acquired by the transition data acquiring section 212. Then, the motion vector calculating section 250 calculates a motion vector indicative of the difference between the position of the macroblock specified by the identical partial region specifying section 240 that there is any partial region having the same image content and the position of the partial region included in the I picture generated by the I picture generated section 282 and the P picture generated by the P picture generating section 284, of which image content is the same as that of the specified macroblock. Then, the B picture generating section 286 generates a B picture including the motion vector calculated by the motion vector calculating section 250, which represents the macroblock specified by the identical partial region specifying section 240 that there is the partial region having the image content the same as that of the I picture or the P picture reproduced at a timing before or after the B picture is generated.

The DCT performing section 290 performs a discrete cosine transform on the moving image components generated by the moving image component generating section 280 as the I picture, the P picture and the B picture to calculate a DCT coefficient. Here, the DCT performing section 290 calculates the DCT coefficient for any macroblock requiring the DCT in the moving image components, such as the macroblock from which the pixel data is generated by the moving image component generating section 280, of course. The DCT coefficient quantizing section 292 quantizes the DCT coefficient calculated by the DCT performing section 290 to generate a moving image components of which amount of data is compressed. The encoding section 294 encodes the moving image components generated by the DCT coefficient quantizing section 292 to generate a moving image including the moving image components of which amount of data is compressed. Specifically, the encoding section 294 may perform run-length coding and Huffman coding on the moving image components The image output section 205 outputs the moving image including the moving image components generated by the encoding section 294 to the outside of the moving image generating section 100. For example, the image output section 205 outputs the moving image on a recording medium such as a DVD.

Thus, the moving image generating section 100 changes the image content for each macroblock in each picture to represent the macroblocks included in the P picture or the B picture other than the I picture by the motion vector of the I picture or the P picture which is reproduced at the previous or the following timing. As described above, in the moving image generating apparatus 100 according to the present embodiment, the moving image generating section 214 generates a plurality of moving image components from the plurality of still images by defining a partial region included in a moving image component as the minimum unit of transition of the still images in the moving image and generates a compressed moving image including the plurality of generated moving image components. Accordingly, the moving image generating apparatus 100 can efficiently generate a moving image from the still images. Here, the still images according to the present embodiment may be images including animation, and also may be partial images in one image including the animation. The moving image generating apparatus 100 may generate animation by the plurality of still image. In this case, the moving image generating section 100 can generate animation more speedily than the case that firstly generates pixel data for the images constituting animation and then encodes the image by MPEG, of course.

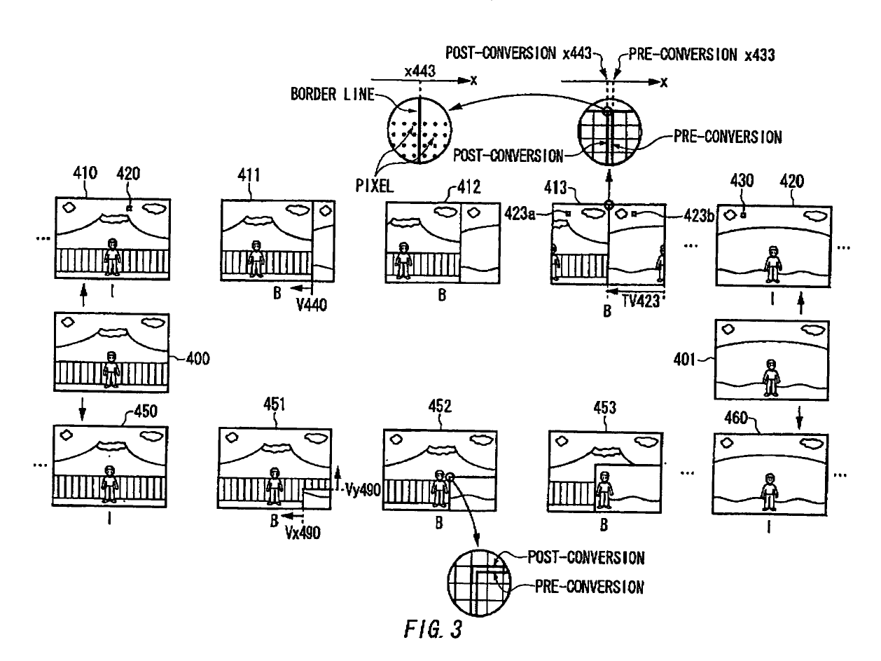

FIG. 3 shows an example of converting transition data by the transition data converting section 220. In the example of FIG. 3, the moving image generating section 214 generates a moving image indicative of transition of images. The summary of the operation to generate a moving image in FIG. 3 is as follows. The transition data acquiring section 212 acquires transition data as the transition data indicative of transition of still images that a still image 400 transfers to the leftmost of the display region while a still image 401 is transferred from the rightmost at a speed the same as that of the still image 400. Specifically, the transition data acquiring section 212 acquires transition data which defines a transition speed V440 at the displayed border line between the still image 400 and the still image 401. Additionally, the moving image generating section 214 generates an I picture 410 and an I picture 420 using the still image 400 and the still image 401 in FIG. 3.

Hereinafter, the operation of the transition data converting section 220 will be described in detail by taking as an example the detailed data conversion on a B picture 413. The transition data converting section 220 calculates the position of the border line X433 of the B picture 413 by integrating in terms of time the speed at the border line from at which the I picture 400 is reproduced to at which each picture is reproduced. Then, the transition data converting section 220 specifies the position X443 of the border line of the macroblock proximate to the calculated position of border line and generates transition data in which the position of border line is adjusted to the specified position. Here, the meaning of that the position of the border line is adjusted to the specified position is that the position of border line is determined such that the pixel column adjacent to the position X433 in the B picture 413 is corresponded to the pixel column of the rightmost of the still image 400, and the pixel column adjacent to the right side of the pixel column in the B picture 413 is corresponded to the pixel column of the leftmost of the still image 401.

Thus, the transition data converting section 220 converts transition data such that the transition of the border line in each picture is approximate to the transition of the border line indicated by the transition data while the position of the border line is transferred by the width for an integer number of partial regions in continuous pictures.

Then, the motion vector calculating section 250 calculates the motion vector of the border line e.g. TV423 in the B picture 413 from the transition data converted by the transition data converting section 220. For example, the motion vector calculating section 250 calculates a motion vector for referring the macroblock 420 which represents the image content of a macroblock 423a and a motion vector for referring the macroblock 430 which represents the image content of a macroblock 423b using a motion vector TV423 of the border line from the I picture 410. Here, the difference image data for each of the macroblocks in the B picture 413 is 0.

For another example of transition of images in FIG. 3, the moving image generating section 214 generates a moving image in which the display is transferred from the still image 400 to the still image 401 and in which a region for displaying the image content of the still image 401 is extended from the bottom right to the upper left. Specifically, the moving image generating section 214 generates an I picture 450 from the still image 400 and generates an I picture 460 which is reproduced next to the I picture 450 from the still image 401. Specifically, the transition data acquiring section 212 acquires transition data indicative of a transition speed Vx490 and a transition speed Vy490 for each of the displayed border lines in the X direction and the Y direction, respectively.

Then, the transition data converting section 220 converts the transition data such that X coordinate and Y coordinate of the displayed border line calculated based on the Vx490 and the Vy490 is adjusted to the position of the border line of the macroblocks. The detailed operation to adjust the X coordinate and the Y coordinate of the displayed border line to the position of the border line of macroblocks is the same as the operation to adjust the position of the border line of the moving image component 413 to the position of the border line of macroblocks as described above, so that the description is omitted.

Therefore, all of the macroblocks included in the B pictures 451, 452 and 453 do not include any displayed border line, so that the image contents of all macroblocks are included in the previous and next I pictures. Accordingly, the image contents of all macroblocks for the B pictures 451, 452 and 453 can be represented by the motion vector component “0” and the difference image signal “0”.

As described above, the moving image generating apparatus 100 can directly obtain the motion vector and the difference image signal for all macroblocks by adjusting the position of the border line. Therefore, the moving image generating apparatus 100 can significantly reduce the time for generating a moving image in comparison with the case that pixel data for moving image components is firstly generated and then the moving image is encoded by MPEG. Here, in FIG. 3, it has been described about the case that an I picture in the moving image is generated from one still image for ease of explanation. However, an image obtained by combining a plurality of still images may be generated as the I picture, of course. In this case, the transition data acquiring section 212 may acquire transition data indicating that an image obtained by combining the plurality of still image is generated as the I picture.

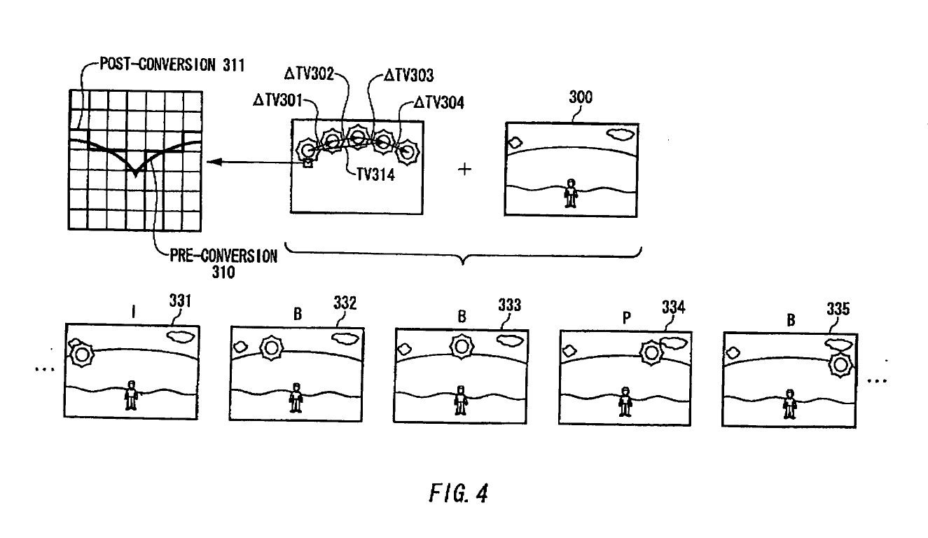

FIG. 4 shows another example of moving data generated by the moving image generating section 214. In FIG. 4, the moving image generating apparatus 100 generates moving data indicative of transition of an object showing the sun against a background of a still image 300. The transition data acquiring section 212 acquires as transition data the difference among the coordinates of the object showing the sun (vectors ΔTV301, 302, 303 and 304) in the pictures continuously reproduced. Additionally, the transition data includes the initial potion of the object. The moving image generating section 214 superimposes the image of the object on the initial position of the object indicated by the transition data of the still image 300 to generate an I picture 331.

Here, the moving image generating section 214 converts the image of the object to an image including one or more macroblocks. Specifically, the moving image generating section 214 converts an outline 310 of the object before being converted so as to adjust to a pixel column 311 of the border line of the macroblocks.

Hereinafter it will be specifically described about an operation to generate a P picture 334. The transition data converting section 220 calculates a vector 314 indicative of transition of the object by sequentially adding vector ΔTV301, 302 and 303 for each I picture 331, 332, 333 and 334 and calculates the position of the object in a P picture 334 based on the calculated vector V314 and the initial position of the object. At this time, the transition data converting section 220 adjusts the position of the object such that the converted outline of the image of the object is corresponded to the outline of the macroblocks based on the calculated position of the object, the converted image of the object including one or more macroblocks and the position of the macroblocks in the P picture 334. At this time, the transition data converting section 220 determines the transition direction and the amount of transition of the position of the object such that the amount of transition from the calculated position of the object such as the transition distance of the centroid of the object is minimized. Thus, the transition data converting section 220 approximates the transition path of the object to the transition path indicated by the transition data.

In this case, the motion vector calculating section 250 calculates the difference between the position of the object included in the P picture 334 after being adjusted and the position of the object included in the I picture 331 of which image content is the same as the adjusted object. Then, the P picture generating section 284 represents the image content of the macroblocks included in the object in the P picture 334 by the calculated motion vector “0” and the difference image signal. Additionally, the identical partial region specifying section 240 specifies the macroblocks in which the object is not included in the I picture 331 over the range constituting each macroblock among the macroblocks which do not include the object in the P picture 334. Then, the motion vector calculating section 250 calculates the motion vector of the specified macroblock as 0. Then, the P picture generating section 284 represents the image content of the specified macroblock by the difference image signal “0” and the motion vector “0” which is calculated by the motion vector calculating section 250 to generate a P picture 334.

Thus, the moving image generating apparatus 100 can easily calculate the motion vector and the difference image signal based on the transition data without block matching. Here, it has been described that the difference between the coordinate for each object of the picture continuously reproduced is stored as transition data, for example. However, transition data acquiring section 212 may acquire as the transition data the time-dependent data for the speed of the object In this case, the time-dependent data for the speed of the object is integrated in terms of time from the I picture to calculate the object transition vector to which the object is transferred.

As described above, the moving image generating apparatus 100 can generate moving data compressed by MPEG from the transition data more speedily than the case that the moving image is generated by generating pixel data for each picture once and block matching between the pixel data and the I picture or P picture. Here, it has been described about the operation of the moving image generating section 214 by taking the transition of the object as a specific example. The transition data may be the transition of a region included in the still image (I picture). In this case, the moving image generating apparatus 100 also can speedily generate a moving image by converting transition data through the procedure the same as the operation described with reference to FIG. 4. Additionally, the moving image generating apparatus 100 can acquire the transition data indicative of the combination of transition of the displayed border line with reference to the above-described two examples in FIG. 3 and the transition of the object described with reference to FIG. 4, of course. In this case, the moving image generating apparatus 100 also can convert the display border line, the outline of the object and the position of the object for each macroblock by the combination of the operations described with reference to FIG. 3 and FIG. 4.

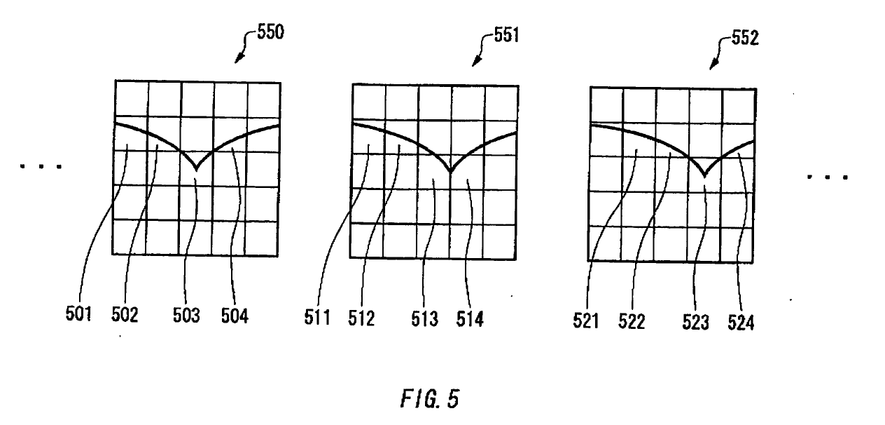

FIG. 5 shows an example of generating a moving image in which an object is transferred by a transition width smaller than the width for a macroblock. In FIG. 5, the object moves by the width half as long as a macroblock. Here, FIG. 4 shows an example of a moving image including an object which transfers against the background. Then, the image content for each macroblock included in the background around the movement path through which the object transfers is the same. Here, the meaning that the image content is the same includes the case that the background is formed by the macroblocks with the same pattern and also includes the case that the background such as a background with only black and only white is formed by macroblocks with single color and no pattern, of course.

In FIG. 5, macroblocks 501, 502, 503 and 504 included in a picture 550 reproduced at one timing include the outline of the object and also include the image of the object and the image of the background. Then, a picture 551 reproduced at the next timing includes an image in which the object is transferred by the distance half as long as the width of a macroblock in the X direction. Macroblocks 511, 512, 513 and 514 include the image of the object and the image of the background.

Then, a picture 552 reproduced at the timing next to the timing at which the picture 551 is reproduced includes an image in which the object is further transferred by the distance half as long as the width of a macroblock in the X direction. Macroblocks 521, 522, 523 and 524 include the image of the object and the image of the background. Here, the image content for each of the macroblocks included in the background around the object is the same, so that the image content for each of the macroblocks 521, 522, 523 and 524 is the same as the image content for each of the macroblocks 501, 502, 503 and 504. Accordingly, the image content for each of the macroblocks 521, 522, 523 and 524 can be represented by the motion vector having the width for one macroblock in the X direction and the difference image signal “0” with reference to the macroblocks 501, 502, 503 and 504, respectively. Accordingly, generating the picture 550 as an I picture or P picture and generating the picture 552 as such as a P picture or B picture, the moving mage generating apparatus 100 can represent also the image content of the macroblock including the border line between the object and the background by the motion vector and the difference image signal “0”

Additionally, it has been described that the object is Transferred by the distance half as long as the width of a macroblock, for example. However, the object can be transferred by the distance as long as one integers of the width of a macroblock. For example, when the object is transferred by the distance as long as one third of the width of a macroblock, the image content of the macroblock of the picture subsequently generated can be represented by the motion vector for referring the macroblock in the picture from which pixel data is generated by generating the image data of the macroblocks in at least two pictures. Here, the object may be transferred in the Y direction, the X direction and the Y direction, of course.

As described above, the moving image generating section 214 may generate a plurality of pictures in which the transition region is transferred by the width as long as one integers of the width of the partial region in the moving image. Additionally, the transition data converting section 220 may concert the transition data acquired by the transition data acquiring section 212 to transition data indicative of transition by the width as long as one integers of the width of the partial region.

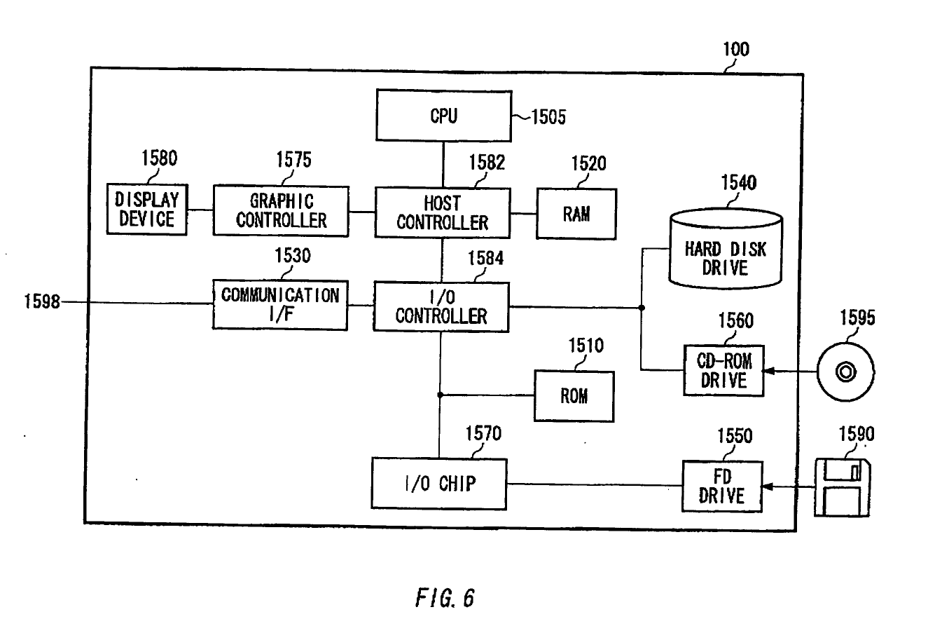

FIG. 6 shows an example of the hardware configuration of the moving image generating apparatus 100. The moving image generating apparatus 100 includes a CPU periphery having a CPU 1505, a RAM 1520, a graphic controller 1575 and a display 1580 which are connected through a host controller 1582 each other, an input/output unit having a communication interface 1530, a hard disk drive 1540 and a CD-ROM drive 1560 which are connected to the host controller 1582 through an input/output controller 1584 and a legacy input/output unit having a ROM 1510, a flexible disk drive 1550 and an input/output chip 1570 which are connected to the input/output controller 1584.

The host controller 1582 connects the RAM 1520 to the CPU 1505 and the graphic controller 1575 which access the RAM 1520 with a high transfer rate. The CPU 1505 operates according to the programs stored in the ROM 1510 and the RAM 1520 to control each unit. The graphic controller 1575 obtains image data generated on a frame buffer provided in the RAM 1520 by the CPU 1505 and displays the same on the display 1580. Alternatively, the graphic controller 1575 may include therein a frame buffer for storing image data generated by the CPU 1505.

The input/output controller 1584 connects the host controller 1582 to the hard disk drive 1540, the communication interface 1530 and the CD-ROM drive 1560 which are relatively high-speed input/output units. The lard disk drive 1540 stores the program and data used by the CPU 1505. The communication interface 1530 is connected to a network communication device 1598 to transmit/receive the data or program. The CD-ROM drive 1560 reads the program or data from the CD-ROM 1595 and provides the same to the hard disk drive 1540 through the RAM 1520.

The ROM 1510, and the flexible disk drive 1550 and input/output chip 1570 which are relatively low-speed input/output units are connected to the input/output controller 1584. The ROM 1510 stores a boot program executed by the moving image generating apparatus 100 at activating and a program depending on the hardware of the moving image generating apparatus 100. The flexible disk drive 1550 reads the program or data from a flexible disk 1590 and provides the same to the hard disk drive 1540 and the communication interface 1530 through the RAM 1520. The input/output chip 1570 connects various input/output units through the flexible disk drive 1550 and such as a parallel port, a serial port, a keyboard port and a mouse port

The program executed by the CPU is stored in a recording medium, such as the flexible disk 1590, the CD-ROM 1595, or an IC card and provided by the user. The program stored on the recording medium may be compressed and not compressed. The program is installed from the recording medium to the hard disk drive 1540, read in the RAM 1520 and executed by the CPU 1505.

The program executed by the CPU 1505 causes the moving image generating apparatus 100 to function as the induction input section 200, the image output section 205, the image storage section 210, the transition data acquiring section 212 and the moving image generating section 214 described with reference to FIG. 1-FIG. 5. Additionally, the program causes the image generating section 214 to function as the section data converting section 220, the identical partial region specifying section 240, the motion vector calculating section 250, the moving image component generating section 280, the DCT performing section 290, the DCT coefficient quantizing section 292 and encoding section 294. Further, the program causes the moving image component generating section 280 to function as the I picture generating section 282, the P picture generating section 284 and the B picture generating section 286.

The above-described program may be stored in au external storage medium. The recording medium may be, in addition to the flexible disk 1590 and the CD-ROM 1595, an optical storage medium such as a DVD and a PD, a magneto-optical recording medium such as a MD, a tape medium and a semiconductor memory such as an IC card. Additionally, a storage media such as a hard disk or a RAM which is provided in the server system connected to a private communication network or Internet is used as the recording medium to provide the program to the moving image generating apparatus 100 through the network.

While the present invention have been described with the embodiment, the technical scope of the invention not limited to the above described embodiment. It is apparent to persons skilled in the art that various alternations and improvements can be added to the above-described embodiment. It is apparent from the scope of the claims that the embodiment added such altercation or improvements can be included in the technical scope of the invention.

What is claimed is:

1. A moving image generating apparatus that generates a moving image in which a plurality of still images are transferred, comprising:
a transition data acquiring section that acquires transition data indicating how are the plurality of still images transferred in the moving image; and
a moving image generating section that generates a plurality of moving image components compressed into each partial region from the plurality of still images based on the transition data acquired by the transition data acquiring section and that generates a compressed moving image including the plurality of generated moving image components, wherein
the moving image generating section generates a plurality of moving image components from the plurality of still images by defining a partial region included in the moving image component as the minimum unit of transition of still images in the moving image and generates a compressed moving image including the plurality of generated moving image components.

2. The moving image generating apparatus as claimed in claim 1, wherein
the transition data acquiring section acquires transition data indicating how is at least a part of transition region in the still images transferred in the moving image, and
the moving image generating section generates the plurality of moving image components in which the transition region is transferred by the width for an integer number of partial regions.

3. The moving image generating apparatus as claimed in claim 2, wherein the moving image generating section includes:
a transition data converting section that converts the transition data indicative of transition of the transition region acquired by the transition data acquiring section to transition data indicative of transition by the width for au integer number of partial regions, and
a moving image component generating section for generating the plurality of moving image components based on the transition data converted by the transition data converting section.

4. The moving image generating apparatus as claimed in claim 3, wherein the transition data converting section converts the transition data acquired by the transition data acquiring section to transition data of which moving path is more approximate to the transition data acquired by the transition data acquiring section among the transition data indicative of the transition by the width for an integer number of partial regions.

5. The moving image generating apparatus as claimed in claim 2, wherein the moving image generating section includes:
a motion vector calculating section that calculates a motion vector of the transition region which indicates the difference between the position of the transition region in one moving image component and the position of the transition region in the other moving image component, and
a moving image component generating section that generates an image component of a partial region included in the transition region in the plurality of moving image components in which the transition region is transferred by the width for an integer number of partial regions by representing that the image content of the partial region included in the transition region in the plurality of moving image components is the same as that of the moving region in the other moving image component by the moving vector calculated by the motion vector calculating section.

6. The moving image generating apparatus as claimed in claim 2, wherein
the transition data acquiring section acquires transition data indicating how is at least of a part of change region of the still images changed in the moving image, and
the moving image generating section generates the plurality of moving image components in which the change region is changed for each of the integer number of partial regions.

7. The moving image generating apparatus as claimed in claim 6, wherein the moving image generating section includes:
a transition data converting section that converts the transition data indicative of the change of the change region, which is acquired by the transition data acquiring section to transition data indicative of the change for each of the integer number of partial regions, and
a moving image component generating section that generates the plurality of moving image components based on the transition data converted by the transition data converting section.

8. The moving image generating apparatus as claimed in claim 1, wherein
the moving image generating section includes:
an identical partial region specifying section that specifies whether there is any partial region having the image component the same as that of each of the partial region other than the partial region which is transferring included in one moving image component based on the transition data acquired by the transition data acquiring section, and
a motion vector calculating section that calculates a motion vector indicative of the difference between the position of the partial region specified by the identical partial region specifying section that there is the partial region having the same image content and the position of the partial region included in the other moving image component, of which image content is the same as that of the specified partial region,
the moving image generating section generates the moving image component including the motion vector calculated by the motion vector calculating section.

9. The moving image generating apparatus as claimed in claim 1, wherein the moving image generating section generates the plurality of moving image components compressed into each of the macroblocks from the plurality of still images by defining a macroblock included in a moving image component as the minimum unit of transition of still images in the moving image based on the transition data acquired by the transition data acquiring section and generates a compressed moving image including the plurality of generated moving image components, which is encoded by MPEG.

10. The moving image generating apparatus as claimed in claim 9, wherein
the moving image generating section includes:
an I picture generating section that generates an I picture being a moving image component from at least one of still images based on the transition data acquired by the transition data acquiring section;
a P picture generating section that generates a P picture being a moving image component based on the transition data acquired by the transition data acquiring section and the I picture generated by the I picture generating section;
an identical partial region specifying section that specifies whether there is the partial region having the image content the same as each of the macroblocks other than the macroblock included in one P picture, which is transferring in the I picture generated by the I picture generating section or the P picture generated by the P picture generating section, which is reproduced at the timing before the P picture is reproduced based on the transition data acquired by the transition data acquiring section; and
a motion vector calculating section that calculates a motion vector indicative of the difference between the position of the macroblock specified by the identical partial region specifying section that there is the partial region having the same image content and the position of the partial region included in the I picture generated by the I picture generating section or the P picture generated by the P picture generating section, of which image content is the same as that of the specified macroblock,
the P picture generating section generates the P picture including the motion vector calculated by the motion vector calculating section, which represents the macroblock specified by the identical partial region specifying section that there is the partial region having the image content the same as that of the I picture or P picture reproduced at the previous timing.

11. The moving image generating apparatus as claimed in claim 10, wherein
the moving image generating section further includes a B picture generating section that generates a B picture being a moving image component based on the transition data acquired by the transition data acquiring section, the I picture generated by the I picture generating section and the P picture generated by the P picture generating section,
the identical partial region specifying section specifies whether there is the partial region having the image content the same as that of each of the macroblocks other than the macroblock included in the B picture, which is transferring in the I picture generated by the I picture generating section or the P picture generated by the P picture generating section, which is reproduced at the timing before/after the B picture is reproduced based on the transition data acquired by the transition data acquiring section,
the motion vector calculating section calculates the motion vector indicative of the difference between the position of the macroblock specified by the identical partial region specifying section that there is the partial region having the same image content and the position of the partial region included in the I picture generated by the I picture generating section or the P picture generated by the P picture generating section, of which image content is the same as that of the specified macroblock, and
the B picture generating section generates the B picture including the motion vector calculated by the motion vector calculating section, which represents the macroblock specified by the identical partial region specifying section that there is the partial region having the image content the same as that of the I picture or P picture reproduced at the timing before/after the B picture is reproduced.

12. A moving image generating method for generating a moving image in which a plurality of still images are transferred, comprising:
acquiring transition data indicating how are the plurality of still images transferred in the moving image; and
generating a plurality of moving image components compressed into each partial region from the plurality of still images based on the transition data acquired in the transition data acquiring step and generating a compressed moving image including the plurality of generated moving image components, wherein
the moving image generating step generates a plurality of moving image components from the plurality of still images by defining a partial region included in the moving image component as the minimum unit of transition of still images in the moving image and generates a compressed moving image including the plurality of generated moving image components.

13. A program for a moving image generating apparatus that generates a moving image in which a plurality of still images are transferred, the program to the moving image generating apparatus to function as:
a transition data acquiring section that acquires transition data indicating how are the plurality of still images transferred in the moving image; and
a moving image generating section that generates a plurality of moving image components compressed into each partial region from the plurality of still images based on the transition data acquired by the transition data acquiring section and that generates a compressed moving image including the plurality of generated moving image components, wherein
the moving image generating section generates a plurality of moving image components from the plurality of still images by defining a partial region included in the moving image component as the minimum unit of transition of still images in the moving image and generates a compressed moving image including the plurality of generated moving image components.
